(19) United States
(12) Patent Application Publication
(10) Pub. No.: US 2011/0273762 A1
(43) Pub. Date: Nov. 10, 2011

(54) Electrooptic Crystal and Device

(75) Inventor: David Nugent, Durham (GB)

(73) Assignee: Kromek Limited

(21) Appl. No.: 13/126,266

(22) PCT Filed: Nov. 23, 2009
(86) PCT No.: PCT/GB2009/051586

§ 371 Date: Jun. 6, 2011

(30) Foreign Application Priority Data
Nov. 27, 2008 (GB) 0821670.7

(51) Int. Cl. G02F 1/00

(52) U.S. Cl. 359/322

(57) ABSTRACT

An electro optic crystal arrangement in particular comprising or for use in or as a laser modulator suitable for use in an intracavity modulator for a CO₂ laser such as a Q-switched pulsed CO₂ laser, and the use of such a crystal arrangement in an electro optic device such as a laser modulator are described. The electro optic crystal arrangement comprises a bulk single crystal of cadmium telluride grown on a semiconductor substrate and preferably a germanium substrate, for example by physical vapour deposition

The present invention relates to electrooptic crystals and devices, and in particular to the performance of optical quality electrooptical crystals used as electrooptic modulators, for example in or with lasers and laser systems. The invention relates most particularly to Q-switched carbon dioxide (CO₂) lasers and laser systems.

The use of cadmium telluride (CdTe) crystals as electrooptic material for intracavity modulators in CO₂ lasers is known (see for example James E Kiefer et al, Journal of Quantum Electronics, Vol. QE-8, No 2, February 1972 entitled “Intracavity CdTe Modulators for CO₂ Laser”, pp 173-179).

CdTe is birefringent, that is to say its refractive index changes when an electric field is applied across the material in the [110] crystal direction. CdTe crystals can, when oriented in the right direction, act as an optical wave plate with a voltage controlled retardation and can electrically modulate the intensity, phase or polarisation of a light beam. The use of CdTe in CO₂ lasers is particularly attractive since the optical absorption coefficient at the CO₂ emission line (10.6 μm) is lower than other birefringent materials.

In laser modulator applications, a voltage is applied across the CdTe crystal to induce changes in the phase of light travelling through the substance. When used in conjunction with polarising plates, the CdTe is modulated to generate ultra-fast Q-switched laser pulses. Using Q-switching techniques creates giant optical pulses with very high repetition rates to emit large quantities of laser energy with little thermal inertia, thereby minimising target damage.

Laser modulators have typically used CdTe rods with dimension in the order of 5 mm×5 mm×50 mm. Achieving long-length CdTe crystals is particularly important since the voltage required to achieve a certain phase change is indirectly proportional to the optical path length. Shorter crystals can be used. However the DC voltage applied across them must be increased accordingly. Higher voltages are both more expensive to generate and also are more likely to cause destructive corona discharges across the CdTe crystal

In use, the temperature of the CdTe crystal has to be stabilised to minimise the likelihood of mechanical breakages caused by rapid thermal expansion or contraction, and the deleterious effects on the laser M2 factor caused by temperature-induced perturbations in the refractive index. The thermal conductivity of CdTe is poor compared to many semiconductor materials. This is problematic in an intra-cavity CO₂ laser modulator environment where thermal lenses caused by localised heating will destabilize the laser cavity and generate lateral mode filamentation. In extreme cases, larger temperature deviations can irreversibly reduce the electrical resistance of the CdTe and thereby disable the formation of high electric fields and birefringent effects. To control the temperature of the CdTe crystal, indium cushions are typically formed on each side of the crystal. For additional cooling effect patent publication U.S. Pat. No. 7,280,569 describes cooling fluid passed through channels in metal bars arranged symmetrically around the crystal.

CdTe crystals in laser modulator applications have typically though not exclusively been manufactured through melt processes such as the Travelling Heater Method (THM) and the Bridgman process. The melt processes have produced very low yields of suitable quality single-crystal material in limited sizes. CdTe material is brittle and tends to chip easily during machining, resulting in high scrap rates. The use of CdTe in laser modulator applications has been limited by a shortage of single crystals of suitable dimensions with the material that is available being very expensive. It is also known that the CdTe crystals can suffer damage from RF arcing if it is too close to metal parts used in housings around the crystal, even when a dielectric is used to separate the crystal from such metal parts. These problems of supply and RF arcing have resulted in a renewed interest in mechanical modulation techniques, such as the mechanical Q-switch proposed in patent application US2008/0144675.

In summary, the use of CdTe in laser modulator applications has been limited by a number of problems including poor mechanical strength, poor thermal properties, and small size. There is a need for an improved electrooptic crystal for application such as application as a laser modulator in Q-switched pulsed CO₂ lasers.

According to the invention in a first aspect there is provided an electrooptic crystal arrangement comprising single-crystal cadmium telluride grown on a substrate of semiconductor material.

According to the invention in a further aspect there is provided the use of an electrooptic crystal arrangement comprising bulk single-crystal cadmium telluride grown on a substrate of semiconductor material in an electro-optical device, for example as, or as an active component of, an electrooptic modulator and more particularly for example as, or as an active component of, a laser modulator.

The substrate is at least semi-insulating and is preferably a semiconductor material. It is desirable that any mismatch between the substrate crystal lattice and the CdTe crystal lattice is kept to a minimum. Preferably the substrate crystal lattice is an analogous cubic lattice to the zinc blende lattice of CdTe for example comprising another zinc blende lattice or a diamond cubic lattice. Preferably, the lattice constant of the substrate crystal lattice differs from the lattice constant of the bulk single-crystal cadmium telluride by no more than 20%. The substrate is for example germanium (diamond cubic) or gallium arsenide (zinc blende).

The cadmium telluride single crystal is preferably grown thereon by a physical vapour phase deposition process.

The electrooptic crystal arrangement is preferably adapted for use in and/or comprises a laser modulator, and is preferably adapted for use in and/or comprises a laser modulator for use in Q-switched pulsed CO₂ lasers. In particular the electrooptic crystal arrangement comprises a modulator for or in a Q-switched pulsed CO₂ lasers.

The modulator can be an intracavity or extracavity modulator. The modulator is preferably an intracavity modulator for a CO₂ laser such as a Q-switched pulsed CO₂ laser.

Thus, in the preferred case, the electrooptic crystal arrangement comprises an intracavity modulator for a CO₂ laser comprising a bulk CdTe single crystal on a germanium or gallium arsenide substrate.

In a further aspect there is provided a laser modulator comprising an electrooptic crystal arrangement as above described, for example being an intracavity modulator for a Q-switched pulsed CO₂ laser. In a further aspect there is provided a laser such as a Q-switched pulsed CO₂ laser incorporating such a modulator. The modulator is of cadmium telluride. However the problems conventionally associated with cadmium telluride, such as poor mechanical strength, poor thermal properties, and small size, can be mitigated by depositing the CdTe on a substrate such as a Ge or GaAs substrate, whose crystal structure is compatible and whose thermal and mechanical properties are significantly better than CdTe. In this way, the performance of the CdTe is enhanced by its supporting substrate.

In summary, the combination of CdTe single crystal as-grown by means of physical vapour deposition on a compatible crystal substrate such as germanium or gallium arsenide substrate confers one or more of the following advantages over conventional CdTe crystals manufactured through melt processes.

First, germanium or gallium arsenide is much stronger than CdTe and thus will better withstand mechanical and thermal shocks during the manufacturing process. Second, the thermal conductivity of the substrate is better. For example the thermal conductivity of germanium is ten times better than CdTe (indeed it is nearly as good as indium) and therefore will act as an efficient heat sink. Third, unlike indium, the thermal expansion coefficient of germanium and gallium arsenide are closely similar to CdTe; meaning the substrate is thermally and mechanically compatible with the CdTe crystal. Fourth, the possibility of growing longer CdTe bars raises the prospect of reducing proportionally the voltage required to achieve phase retardation and thereby Q-switching in the laser cavity; this will reduce the cost and complexity of the high-voltage generator. Fifth, doping levels may be adjusted to achieve high resistivity material with excellent uniformity.

According to the invention in a further aspect there is provided a method for fabrication of an electrooptic crystal arrangement comprising preparation of a suitable substrate and growth thereon of bulk single crystal cadmium telluride by means of physical vapour deposition.

The substrate for growing the CdTe crystal is a semiconductor material and is for example a germanium or gallium arsenide substrate.

The method is in particular a method of growing a bulk CdTe crystal on a germanium substrate to act as an intracavity modulator for a CO₂ laser such as a Q-switched pulsed CO₂ laser.

The electroptically active component of a crystal arrangement in accordance with the invention comprises a CdTe single crystal. This is a birefringent material as above described. A fundamental requirement of the birefringent properties of a CdTe crystal is that the zinc blende 4̅ 3 crystalline symmetry is exhibited. This will determine the impurity and stoichiometry tolerances required of the CdTe single crystal, which must be sufficient that the necessary 4̅ 3 crystalline symmetry is substantially maintained.

For the intended application a CdTe crystal will comprise a bulk single crystal. As used generally in this technology the term “bulk crystal” will be understood in the sense as distinguishing from thin film, and might in principle indicate a minimum dimension of at least 1 mm, and preferably of at least 2 or more preferably 3 mm. Given the preferred application for application as intracavity modulators for CO₂ lasers, the CdTe crystals would preferably need to be grown to a minimum thickness in a transverse dimension of at least 5 mm. CdTe crystals of this thickness can be grown by a known physical vapour phase deposition process such as described in EP1019568.

The semiconductor substrate might typically have a thickness between about 100 and 1000 μm, preferably of at least 200 μm for mechanical stability and can have any available size.

When CdTe crystals are grown on a suitable substrate such as above described via a physical vapour phase deposition process the crystal grows in the [001] direction needed for the electrooptic effect. The substrate is thus used both to seed the crystal growth from the vapour phase and to support the crystal during further processing operations after crystal growth.

The electrooptic crystal arrangement may further comprise an intermediate layer to accommodate mismatch between the substrate crystal lattice and the CdTe crystal lattice. The intermediate layer may have a thickness of between about 10 and 1000 μm, preferably in the region of 100 to 200 μm.

The intermediate layer may additionally comprise a transition region or, alternatively, the intermediate layer may comprise only a transition region. The transition region will typically be small compared to the substrate and bulk crystal material, and therefore the effects are negligible on the overall device.

The intermediate layer should have a lattice structure compatible with the substrate. For example, the intermediate layer may have a zinc blende or diamond cubic lattice. The intermediate layer may be of CdTe or it may be of a different material.

The intermediate layer may comprise a transition region between the intermediate layer on the substrate and the CdTe bulk crystal material or the transition region may be in addition to an intermediate layer deposited on the substrate. In one example the transition region and the bulk crystal region can be deposited using the same growth technique, but with an initial variation in the growth parameters during the growth cycle to gradually change the composition and growth rate of the material deposited on the substrate. During the initial deposition the transition region is formed. After completing the change to the material of the bulk CdTe crystal to be deposited, the growth parameter can be optimised to deposit the bulk CdTe crystal material. The change from the transition region to bulk CdTe material might require the CdTe crystal growth apparatus to have a capability to introduce different source materials to be deposited onto the substrate.

In addition to the substrate, intermediate layer, transition region and the bulk CdTe crystal material, additional layers may be deposited. For example, a dielectric layer might be provided to reduce the possibility of RF arcing.

In a particularly preferred embodiment, the substrate is germanium. There are a number of advantages to using a CdTe single crystal grown on a germanium substrate. First, germanium (Knoop hardness=780) is much stronger than CdTe (Knoop hardness=45) and thus will protector the CdTe crystal from mechanical breakages during the manufacturing process. Second, the thermal expansion coefficient of germanium (5.9 μm·m⁻¹·K⁻¹) is very close to that of CdTe (5.9 μm·m⁻¹·K⁻¹), reducing the possibility of damage to the crystal caused by rapid thermal cycling. Third, germanium has good thermal conductivity properties (0.58 W·cm⁻¹·K⁻¹) compared to CdTe (0.06 W·cm⁻¹·K⁻¹) and, therefore, acts as an efficient heat sink for the removal of heat from the CdTe crystal. Indeed the thermal conductivity of germanium is almost as good as Indium (0.82 W·cm⁻¹·K⁻¹). Fourth, the use of vapour deposition techniques to grow CdTe crystals on the germanium substrate presents the possibility of growing longer CdTe bars, which raises the prospect of reducing proportionally the voltage required to achieve phase retardation and thereby Q-switching in the laser cavity. This reduces the cost and complexity of the high-voltage generator. Fifth, doping levels may be adjusted to achieve high resistivity material with excellent uniformity. As noted above, high resistivity is essential to maintain a high electric field and thereby electrooptic effect across the CdTe crystal.

The CdTe crystal can be grown directly onto the germanium substrate or preferably it can be grown onto the germanium substrate with an intermediate layer between the germanium and the CdTe to accommodate mismatch between the germanium and the CdTe crystal lattice. For CdTe the lattice parameter a=6.481 Å and for germanium the lattice parameter a=5.658 Å.

After preparation of the CdTe crystal on the germanium or other substrate a further body, for example of the same material as the substrate, can be attached by suitable bonding means to the CdTe crystal on the opposite side of the crystal to the substrate to give a symmetrical cooling effect.

The CdTe crystal grown on the substrate may be passively or actively cooled. The further body will provide additional passive or active cooling. It is preferable to arrange the cooling effects to provide symmetrical cooling effects to maintain optimum performance of the crystal and in the case of the preferred mode of application in a Q-switched laser of the laser beam.

Electrical contacts are required to be attached to faces of the CdTe crystal adjacent to the faces in contact with the substrate, for example the germanium substrate and germanium heat sink attachment above described. The electrical contacts are required for electrical attachment in order to apply the voltage necessary to produce the switching effect. Conveniently, these may be selected to give an additional cooling effect. The skilled person will appreciate suitable contact structures. For example, indium cushions may be used. As well as providing electrical attachment the indium cushions also give an additional cooling effect giving further protection against temperatures that could result in damage to CdTe crystal properties.

In a preferred application, the electrooptic crystal of the invention comprises a laser modulator incorporated into a Q-switched pulsed CO₂ laser. Using Q-switching techniques, laser modulators can create giant optical pulses with very high repetition rates, for example, peak powers greater than 3 kW with optical pulse intervals in the order of 100 nanoseconds are known.

The invention will now be described by way of example only with reference to the accompanying drawings in which:

FIG. 1 shows a cross section through a prior art CdTe crystal modulator arrangement;

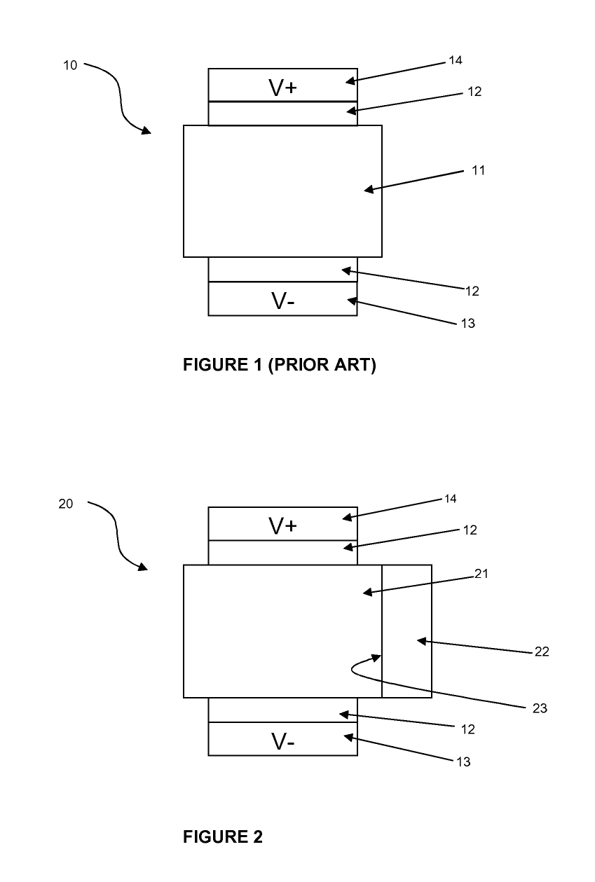

FIG. 2 shows a cross section through a CdTe crystal modulator of the invention;

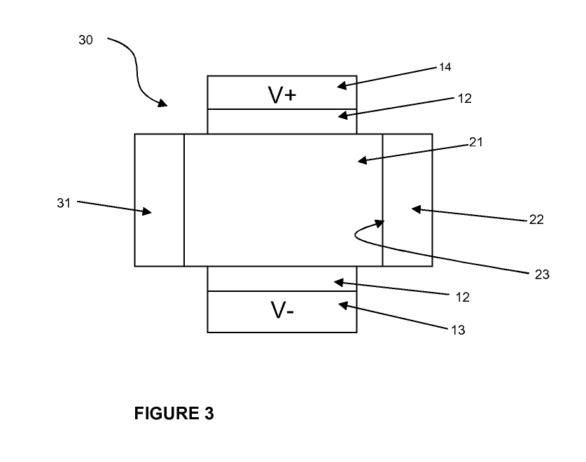

FIG. 3 shows a cross section through a preferred CdTe crystal modulator of the invention.

A modulator 10 of the prior art is shown in FIG. 1 in which a CdTe crystal 11 has indium cushions 12 attached thereto at opposing faces for attachment of an aluminium electrical contact 13 for application of a positive voltage and a further aluminium electrical contact 14 for application of a negative voltage.

The application of a voltage across the CdTe crystal causes a known electrooptic effect suitable for modulating a laser beam.

A modulator crystal assembly 20 of the invention is shown in FIG. 2 in which a single crystal of CdTe 21 is grown on a germanium substrate 22. Electrical contact for application of a voltage to generate an electrooptic effect in the CdTe crystal is made by the attachment of the indium cushions 12 and aluminium electrical contacts 13 and 14. Heat created during the operation of the CdTe crystal as a laser modulator is transferred by thermal conductivity to the germanium substrate onto which the CdTe was grown during a physical vapour deposition process.

The CdTe crystal 21 is a single crystal with dimensions of approximately 50 mm×5 mm×5 mm. The cross section dimension of the CdTe single crystal shown in FIG. 2 is 5 mm×5 mm with the 50 mm dimension in the direction perpendicular to the page.

The 5 mm dimension between the indium cushions 12 corresponds to the crystal direction. The 5 mm dimension between the germanium substrate 21 and germanium material 31 corresponds to the [001] crystal direction and is the direction of crystal growth during the growth of the crystal during the physical vapour phase deposition process, with CdTe material being first deposited on the surface 23 of the germanium substrate.

The germanium substrate 22 gives a heat sink effect to cool the CdTe crystal during operation as a laser beam modulator and maintain the birefringent properties of the CdTe crystal to maintain laser beam performance. The attachment of the indium cushions 12 gives a further cooling effect and improved cooling symmetry.

Cooling the CdTe crystal 21 also maintains the crystal electrical resistance. It is known that the electrical resistance of CdTe can drop to approximately 2% the room temperature value if the crystal is operated at a temperature of 50° C. or above. If the crystal temperature exceeds 100° C. a permanent lowering of electrical resistance can result. The room temperature electrical resistance of CdTe is in the order of 2×10⁸Ω cm.

FIG. 3 shows a preferred embodiment of the invention. The modulator crystal assembly 30 comprises a CdTe single crystal 21 grown on a germanium substrate 22. A further germanium heat sink 31 with dimensions approximately the same as the dimensions of the germanium substrate 22 is attached by suitable bonding means on the crystal face opposite to substrate 22. Electrical contact for application of a voltage to generate an electrooptic effect in the CdTe crystal is made by the attachment of the indium cushions 12 and aluminium electrical contacts 13 and 14. Heat created during the operation of the CdTe crystal as a laser modulator is transferred by thermal conductivity to the germanium substrate onto which the CdTe was grown during a physical vapour deposition process.

The germanium substrate 22 and the germanium heat sink 31 may both be actively cooled to provide additional CdTe cooling.

The CdTe crystal 21 is a single crystal with dimensions of approximately 50 mm×5 mm×5 mm. The cross section dimension of the CdTe single crystal shown in FIG. 3 is 5 mm×5 mm with the 50 mm dimension in the direction perpendicular to the page.

The 5 mm dimension between the indium cushions 12 corresponds to the [110] crystal direction. The 5 mm dimension between the germanium substrate 21 and germanium material 31 corresponds to the [001] crystal direction and is the direction of crystal growth during the growth of the crystal during the physical vapour phase deposition process, with CdTe material being first deposited on the surface 23 of the germanium substrate.

The CdTe crystal 21 becomes birefringent when an electric field is applied along the [110] crystal direction.

Attachment of the germanium material 31 opposite the germanium substrate 22 gives a symmetrical heat sink effect to cool the CdTe crystal during operation as a laser beam modulator and maintain the birefringent properties of the CdTe crystal to maintain laser beam performance. The attachment of the indium cushions 12 gives a further cooling effect and improved cooling symmetry.

In addition to the features illustrated in the FIG. 1 prior art modulator configuration, it is known to use ceramic holders, preferably made from an appropriately thermally conductive material such as BeO, to provide lateral thermal conduction. Such ceramic holders would also find application in the modulator configurations of the invention illustrated in FIGS. 2 and 3.

The modulator arrangement of FIG. 3 is particularly suited to application as an intracavity modulator for a Q-switched pulsed CO₂ laser, but may also be suited to an external modulator for controlling the power transferred through the same.

1. An electrooptic crystal arrangement comprising bulk single-crystal cadmium telluride grown on a substrate of semiconductor material.

2. An electrooptic crystal arrangement in accordance with claim 1 wherein the substrate crystal lattice is an analogous cubic lattice to the zinc blende lattice of CdTe.

3. An electrooptic crystal arrangement in accordance with claim 2 wherein the substrate crystal lattice is zinc blende or diamond cubic.

4. An electrooptic crystal arrangement in accordance with claim 2 wherein the lattice constant of the substrate crystal lattice differs from the lattice constant of the bulk single-crystal cadmium telluride by no more than 20%.

5. An electrooptic crystal arrangement in accordance with claim 1 wherein the substrate is germanium or gallium arsenide.

6. An electrooptic crystal arrangement in accordance with claim 1 wherein the cadmium telluride single crystal is grown on the substrate by a physical vapour phase deposition process.

7. An electrooptic crystal arrangement in accordance with claim 1 comprising an electrooptic modulator.

8. An electrooptic crystal arrangement in accordance with claim 1 comprising a laser modulator.

9. An electrooptic crystal arrangement in accordance with claim 8 comprising a modulator for a Q-switched pulsed CO₂ laser.

10. An electrooptic crystal arrangement in accordance with claim 8 comprising an intracavity modulator.

11. An electrooptic crystal arrangement in accordance with claim 1 wherein the CdTe crystal is grown to a minimum transverse dimension of at least 5 mm.

12. An electrooptic crystal arrangement in accordance with claim 1 further comprising an intermediate layer to accommodate mismatch between the substrate crystal lattice and the CdTe crystal lattice.

13. An electrooptic crystal arrangement in accordance with claim 1 further comprising a further body of the same material as the substrate attached by suitable bonding means to the CdTe crystal on the opposite side of the crystal to the substrate.

14. An electrooptic crystal arrangement in accordance with claim 1 further comprising indium cushions attached to faces of the CdTe crystal adjacent to the faces in contact with the substrate.

15. A laser modulator comprising an electrooptic crystal arrangement in accordance with claim 1.

16. A laser modulator comprising in accordance with claim 15 incorporated into a Q-switched pulsed CO₂ laser.

17. A laser modulator in accordance with claim 15 comprising an intracavity modulator.

18. The use in an electrooptic device including an electrooptic crystal arrangement in accordance with claim 1.

19. The use of an electrooptic crystal in accordance with claim 18 as, or as an active component of, an electrooptic modulator.

20. The use of an electrooptic crystal in accordance with claim 19 as, or as an active component of, a laser modulator.

21. The use of an electrooptic crystal in accordance with claim 18 wherein the substrate is germanium or gallium arsenide.

22. The use of an electrooptic crystal in accordance with claim 18 wherein the cadmium telluride single crystal is grown on the substrate by a physical vapour phase deposition process.

23. The use of an electrooptic crystal in accordance with claim 18 wherein the CdTe crystal is grown to a minimum dimension of at least 5 mm.

24. The use of an electrooptic crystal in accordance with claim 18 as an intracavity modulator in a Q-switched pulsed CO₂ laser.
